(19) United States
(12) Patent Application Publication
(10) Pub. No.: US 2010/0274909 A1
(43) Pub. Date: Oct. 28, 2010

(54) CONNECTION DEVICE AND CONNECTION METHOD

(76) Inventor: Naoyuki Mochida, Tokyo (JP)

Correspondence Address: WENDEROTH, LIND & PONACK L.L.P., 1030 15th Street, N.W., Suite 400 East, Washington, DC, 20005-1503, US

(21) Appl. No.: 12/810,338

(22) PCT Filed: Dec. 25, 2008
(86) PCT No.: PCT/JP2008/003940

§ 371 Date: Jun. 24, 2010

(30) Foreign Application Priority Data
Dec. 27, 2007 (JP) 2007-337926

(51) Int. Cl. G06F 15/16

(52) U.S. Cl. 709/227

(57) ABSTRACT

A connection device that does not require complicated operation by a user an interconnects a single-display conference terminal and the multi-display conference terminal includes an address holding unit (103) configured which holds address information indicating an address of the single-display conference terminal and address information indicating an address of the connection device, a media information obtaining unit (105) which obtains information related to media that each of the single-display conference terminals can process, and holds the entire obtained information as first media information, a session control unit (104) which establishes a session with the multi-display conference terminal using the address information of the connection device and the first media information obtained by the media information obtaining unit (105), while obtaining second media information related to media that the multi-display conference terminal can process, and a media control unit (106) which establishes a session with the single-display conference terminals using the second media information obtained by the session control unit (104) and controls the single-display conference terminals to transmit and receive data.

### TECHNICAL FIELD

The present invention relates to connection devices and connection methods, and particularly relates to a connection device which establishes a connection for transmitting/receiving video data via a network, and a connection method.

### BACKGROUND ART

In recent years, the broadband network is widely available, and video phone services and video conference services on the broadband network are widely used as well.

Conventionally, conference terminals used for video phones and video conferences could only transmit/receive low definition videos at low bit rate. However, in recent years, conference devices capable of using High Definition (HD) video are becoming widely used thanks to the improvement in the network capability and others.

Furthermore, conference terminals called as a telepresence system which increases realistic sensation has started to be in practical use. The telepresence system achieves this effect by transmitting multiple HD videos captured by multiple cameras, receiving the multiple HD videos, and outputting the multiple HD videos to multiple display devices (displays). For example, Patent Literature 1 discloses a conference terminal using the HD video.

In all of the conference terminals described above, the user of the conference terminal on the caller side selects the conference terminal on the callee side which is the communication partner, and performs the originating operation. Subsequently, call control messages are transmitted/received directly between the conference terminals on the caller side and the callee side, via a conference server, or a call control server. When the user of the conference terminal on the callee side responds, the call control messages are transmitted and received between the conference terminals, thereby establishing a call control session between the conference terminals.

The call control message sets the media information indicating information such as the type of codecs, IP addresses, and port numbers that can be transmitted/received by the conference terminals. The conference terminal transmits the data to the callee conference terminal based on the media information, and receives the data from the callee terminal from the callee conference terminal in return. The Session Initiation Protocol (SIP) and the H.323 are widely used as the call control protocol.

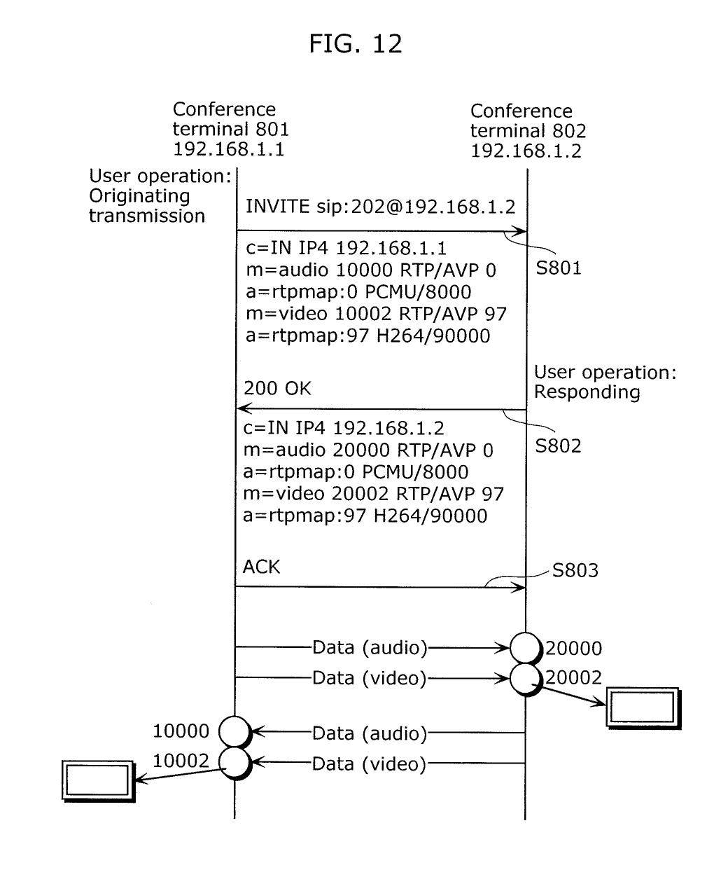

FIG. 12 illustrates an example of flow of the call control message between the conference terminals when the SIP is used.

In the SIP, text-based messages are exchanged between the caller and the callee. The messages include two types of message, that is, a “request” message for requesting the process and a “response” message which is a response to the request message. A message consists of multiple lines. For example, the first line (also referred to as a header of the message) of the “request” message describes a “method” indicating a type of request and “SIP Uniform Resource Identifier (URI)” indicating the destination.

As illustrated in FIG. 12, the user of the conference terminal 801 performs originating operation. The conference terminal 801 that the user performs originating operation transmits, to the conference terminal 802, an “invite” message which is a request message specifying SIP URI, that is, sip:202©192.168.1.2 as the address (S801).

The body of the “invite” message (hereinafter referred to as a message body) sets media information described in the Session Description Protocol (SDP) format.

In the example of FIG. 12, the conference terminal 801 sets the information indicating the IP address of the conference terminal 801 which is the terminal 801 in line c=. The conference terminal 801 further sets information indicating, in the line m=audio and the subsequent line a=, that the media that the conference terminal 801 can receive is PCM u-law and that the reception can be performed on the port 10000, respectively. The conference terminal 801 further sets the information indicating, in the line m=video and the line a=, that the media that the conference terminal 801 can receive is H.264, and the reception can be performed on the port 10002, respectively.

Subsequently, the user of the conference terminal 802 responds when the conference terminal 802 receives the “INVITE” message. The conference terminal 802 whose response operation is performed by the user transmits a “200 OK” message as a message in response to the “INVITE” message from the conference terminal 801 (S802).

The message body of the “200 OK” message sets the media information described in the SDP format.

In the example of FIG. 12, the conference terminal 802 sets the information indicating the IP address of the conference terminal 802 in line c= of the message body. The conference terminal 802 further sets information indicating, in the line m=audio and the subsequent line a=, that the media that the conference terminal 802 can receive is PCM u-law and that the reception can be performed on the port 20000, respectively. The conference terminal 802 further sets the information indicating, in the line m=video and the line a=, that the media that the conference terminal 802 can receive is H.264, and the reception can be performed on the port 20002.

Subsequently, when the “200 OK” message is received, the conference terminal 801 transmits an “ACK” message which is a request message notifying that the session is established to the conference terminal 802 (S803).

After the session is established as described above; that is, after the conference terminals 801, 802, and 803 become able to communicate with one another, transmission and reception of the audio data and the video data starts.

RFC 3264 chapter 10.1 (Non-Patent Literature) describes a call control method for sending multiple videos captured by multiple cameras to the callee, receiving the multiple videos and outputting the videos to multiple display devices, for example. More specifically, a method of setting multiple lines m=video is known.

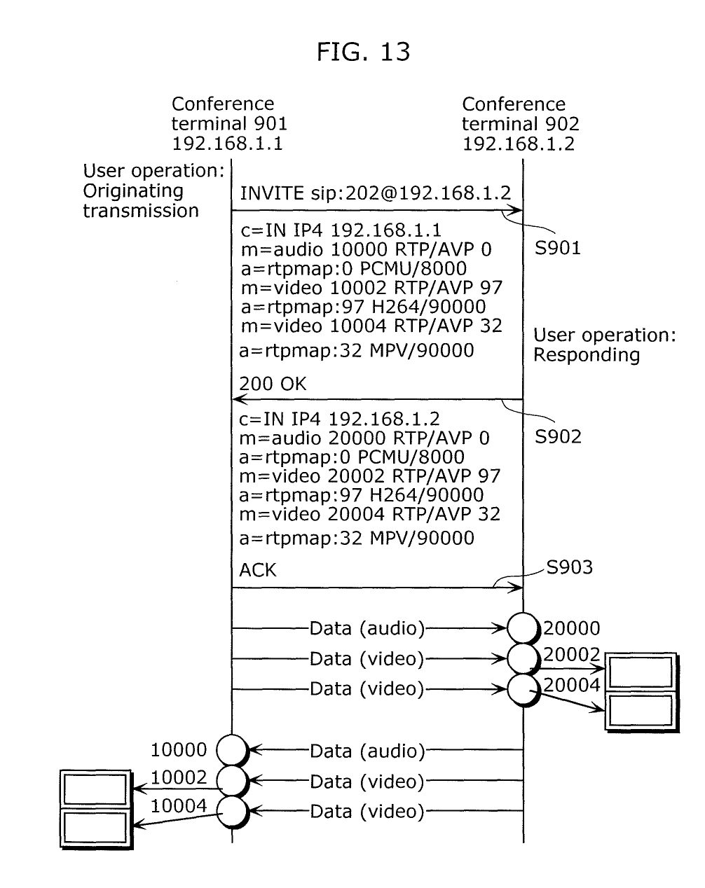

FIG. 13 illustrates an example of flow of the call control messages between the conference terminals when the SIP is used. FIG. 13 illustrates an example using the SIP in which multiple lines m=video are set.

As illustrated in FIG. 13, first, the user of the conference terminal 901 performs the originating operation. The conference terminal 901 on which the user performed originating operation transmits the “INVITE” message to the conference terminal 902 (S901).

Subsequently, the user of the conference terminal 902 responds when the conference terminal 902 receives the “INVITE” message. The conference terminal 902 whose response operation is performed by the user transmits a “200 OK” message as a message in response to the “INVITE” message from the conference terminal 901 (S902).

Here, message bodies of the “INVITE” message transmitted by the conference terminal 901 and the “200 OK” message which is a response message transmitted by the conference terminal 902 set multiple lines of m=video. Multiple lines of m=video indicate that multiple videos can be simultaneously received (and transmitted).

In the example of FIG. 13, in the message body of the “INVITE” message, the information indicating that the conference terminal 901 can receive data on the ports 10002 and 10004 is set on multiple lines m=video. In addition, in the message body of the “200 OK” message, the information indicating that the conference terminal 902 can receive data on the ports 20002 and 20004 in multiple lines m=video.

After receiving “200 OK” message, the conference terminal 901 transmits an “ACK” message notifying that the session is established to the conference terminal 902 (S903).

After the session is established as described above, transmission and reception of the audio data and the video data start between the conference terminal 901 and the conference terminal 902.

In addition, there are methods mainly used for sharing the references for conferences, instead of transmitting/receiving multiple videos to increase the realistic sensation such as the telepresence system described above. The call control protocols used for these methods include H.323 and H.239 used with H.323.

H.323 transmits and receives the call control message directly between the caller and the callee, or via the conference server and the call control server (gate keeper). In H.323, a session in H.225.0 and a channel for transmitting and receiving data in H.245 are set, and the data is transmitted/received using the channel set in H.245.

Furthermore, in H.239, it is possible to extend H.245 to add a channel available for sharing documents.

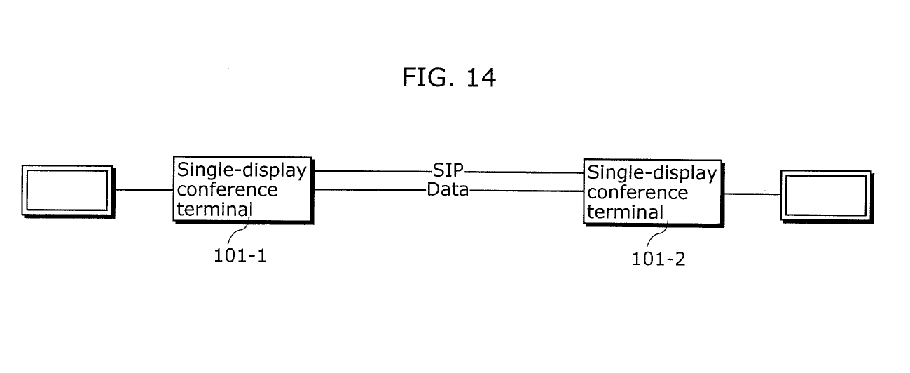

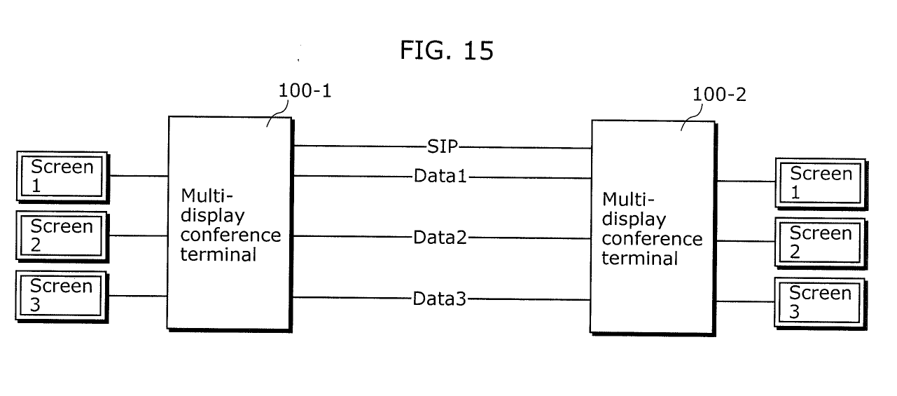

Furthermore, conference terminals each of which transmits/receives one video and can output in one display area (hereinafter referred to as a single-display conference terminal 101) are widely available as conference terminals used for conventional video phones/video conferences (for example, the conference terminal illustrated in FIG. 14). In addition, conference terminals also known as a telepresence system (for example, the terminal illustrated in FIG. 15) that transmits/receives multiple videos and that can output the video to multiple display areas (hereinafter referred to as the multiple-display conference terminal 100) becomes available. In the future, it is expected that the multi-display conference terminals 100 replace the single-display conference terminals 101. Here, it is not estimated that the multi-display conference terminals 100 would replace the single-display conference terminals 100 that have already been in widespread use at once. Instead, the multi-display conference terminals 100 would gradually replace the single-display conference terminals 100 as they are used together.

Here, FIG. 14 illustrates a connection example of the single-display conference terminal 101 when holding a single-screen video conference. FIG. 15 illustrates a connection example of the multi-display conference terminals 100 when holding a multi-screen video conference.

### [Patent Literature] Japanese Unexamined Patent Application Publication No. 9-327009

### DISCLOSURE OF INVENTION

### Technical Problem

However, the interconnection between the single-display conference terminal 101 and the multi-display conference terminal 100 for multiple videos has the following problems.

1) With the communication method using conventional call control, highly realistic video conference using multiple videos cannot be held except for the case where the conference terminals both on the caller side and the callee side can transmit/receive multiple videos. Similarly, with the communication method using H.323 and H.239, video conference using multiple videos cannot be held except for the case where the conference terminals both on the caller side and the callee side are capable of executing the extension function defined by H.239. In other words, there is a problem that the multi-display conference terminal 100 and single-display conference terminal 101 that is widely available cannot be interconnected for using multiple videos.

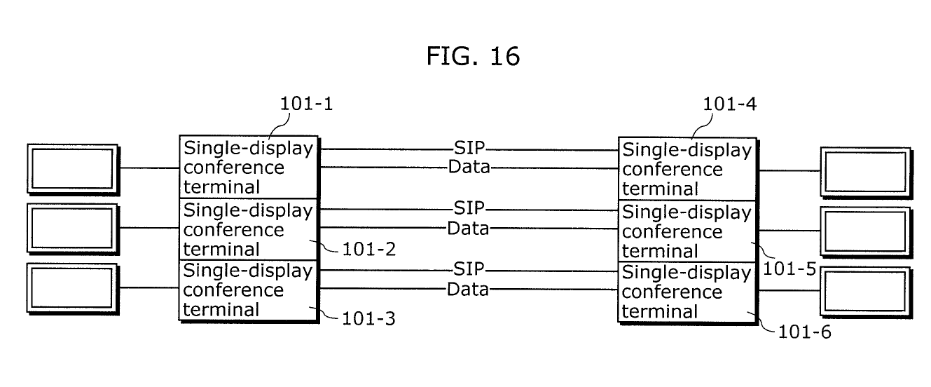

2) It is possible to hold a conference using multiple videos by providing multiple single-display conference terminals 101 and operating, by the user, the multiple single-display conference terminals 101 as a conference terminal on the caller or callee side (for example, see FIG. 16). Here, FIG. 16 illustrates an example of connection when holding a multiple-screen video conference using the single-display conference terminal 101. However, in this case, the user cannot start the conference unless he operates the single-display conference terminals 101 on the callee side while operating his own multiple single-display conference terminals 101. In other words, providing multiple single-display conference terminals 101 for establishing an interconnection using multiple videos poses a problem of complicated operations.

In view of the foregoing, the present invention has been conceived to solve the problem, and it is an object of the present invention to provide a connection device and a connection method that allows an interconnection between the single-display conference terminal and the multi-display conference terminal using multiple videos without complicated operation by the user.

### Solution to Problem

In order to solve the above-described problem, the connection device according to the present invention is a connection device which establishes a connection for transmitting and receiving video data through a network between a single-display conference terminal which receives an item of video data and outputs the video data to one display area and a multi-display conference terminal which receives at least two items of video data and outputs the at least two items of video data to display areas, the connection device including: an address holding unit which holds address information indicating an address, on the network, of each of single-display conference terminals and address information indicating an address, on the network, of the connection device; a media information obtaining unit which obtains information related to media that each of the single-display conference terminals can process, and to hold the entire obtained information as first media information; a session control unit which establishes a session with the multi-display conference terminal using the address information of the connection device and the first media information obtained by the media information obtaining unit, while obtaining second media information related to media that the multi-display conference terminal can process; and a media control unit which establishes a session with the single-display conference terminals using the second media information obtained by the session control unit and to control the single-display conference terminals to transmit and receive data.

With this structure, the connection device obtains the address information and the media information of the single-display conference terminals collectively, holds the obtained information, and performs a call control with the multi-display conference terminal using the address information and the media information. With this, it is possible to establish the session between the single-display conference terminals and the multi-display conference terminal. Thus, the media information can be transmitted and received between the single-display conference terminals and the multi-display conference terminal. Furthermore, the user only needs to operate the connection device. This solves the complexity in operating multiple single-display conference terminals. More specifically, managing and controlling multiple single-display conference terminals together and performing the call control between the single-display conference terminals and the multi-display conference terminal allows skipping complicated operations by the user, and allows interconnection between the single-display conference terminals and the multi-display conference terminal using multiple videos.

Furthermore, the media information obtaining unit may receive, from the single-display terminal, a session starting message including a request for starting the session, and may obtain the first media information from the received session starting message.

Thus, the connection device obtains the first media information that multiple single-display conference terminals can process from a message requesting the start of the session transmitted by multiple single-display conference terminals, and manage the first information collectively.

Furthermore, the media control unit may instruct the single-display conference terminal to start transmitting and receiving the data in the single-display conference terminal by transmitting a response message in response to the session starting message to the single-display conference terminal.

This allows the connection device to instruct the multi-display conference terminal and multiple single-display conference terminals to transmit and receive data between each other.

Furthermore, the media information obtaining unit may transmit, to the single-display conference terminal, an instruction message instructing the single-display conference terminal to transmit the session starting message to the connection device.

Furthermore, the media information obtaining unit may transmit, to the single-display conference terminal, a session starting message which does not include the second media information and is a request message for starting the session, may receive a response message to the session starting message from the single-display conference terminal, and may obtain the first media information from the response message.

Thus, the connection device obtains the first media information that multiple single-display conference terminals can process from a message requesting the start of the session transmitted by multiple single-display conference terminals.

Furthermore, the media control unit may establish the session by transmitting a confirmation message including the second media information in response to the response message to the single display conference terminal, and may instruct the single-display conference terminal to start transmitting and receiving the data in the single-display conference terminal.

This allows the connection device to instruct the multi-display conference terminal and multiple single-display conference terminals to transmit and receive data between each other.

Furthermore, the connection device may further include a storage unit which holds the first media information, in which the media information obtaining unit obtains the first information from the storage unit.

This allows the connection device to obtain, from the storage unit, the first media information that multiple single-display conference terminals can process.

Furthermore, the media information obtaining unit may recognize a type of each of the single-display conference terminals, and may adjust a message transmitted to and received from each of the single-display conference terminals according to recognized types.

Furthermore, the media control unit may recognize the types and to adjust messages each of which is transmitted to and received from each of the single-display conference terminals according to the type.

This allows the connection device to recognize and manage the type of each of the single-display conference terminals. More specifically, this allows a connection between a multi-display conference terminal and a combination of a conference terminal that uses SIP for the call control protocol and a conference terminal that uses H.323 as the call control protocol, for example. Alternatively, this also allows a connection between a multi-display conference terminal and a combination of single-display conference terminals with different versions or protocols due to different manufacturers of the conference terminals. Therefore, it is possible to effectively use the existing single-display conference terminals while introducing multi-display conference terminals with better realistic sensation and to reduce introduction cost of the system.

Furthermore, the connection device may further includes a mixer unit which receives media from the single-display conference terminal or the multi-display conference terminal, converts the received data, and transmits the converted data to the multi-display conference terminal or the single-display conference terminal, in which the session control unit converts the first media information obtained by the media information obtaining unit into third media information related to media that the mixer unit can process, and uses the third media information to establish a session with the multi-display conference terminal instead of the first media information, and the media control unit may establish the session with the single-display conference terminal using the third media information instead of the first media information, transmits and receives data to and from the single-display conference terminals and the multi-display conference terminal through the mixer unit.

This structure increases flexibility and convenience of the data transmitted and received between the multi-display conference terminal and the single-display conference terminals. For example, when transmitting and receiving multiple items of audio data between the single-display conference terminals and the multi-display conference terminal, the audio data may be synchronized or one piece of audio data may be synthesized from the audio media. Furthermore, it is possible to establish a connection even when the codec supported by the multi-display conference terminal is supported by the single-display conference terminal 101.

Note that, the present invention may not only be implemented as a device, but also as an integrated circuit including processing units included in the device, or as a method having the processing units comprising the device as steps.

### ADVANTAGEOUS EFFECTS OF INVENTION

According to the present invention, it is possible to provide a connection device that can interconnect a single-display conference terminal and a multi-display conference terminal using multiple videos without requiring complicated operation by the user, and a connection method.

More specifically, it is possible to transmit and receive media information between the multi-display conference terminal and the single-display conference terminals.

Furthermore, the existence of the connection device in between allows a call control using the media information each of which indicates the media information that the single-display conference terminal can handle. This allows the transmission and reception of the data between the multi-display conference terminal and the single-display conference terminals.

Furthermore, the user may only have to operate the connection device, thus solving the problem caused by the complexity for operating the single-display conference terminals.

Furthermore, the multi-display conference terminal can be connected to a combination of a conference terminal that uses SIP for a call control protocol, and a conference terminal that uses H.323 as a call control protocol. In other words, it is possible to establish a connection between a multi-display conference terminal and a combination of single-display conference terminals with different versions or protocols due to different manufacturers of the conference terminals.

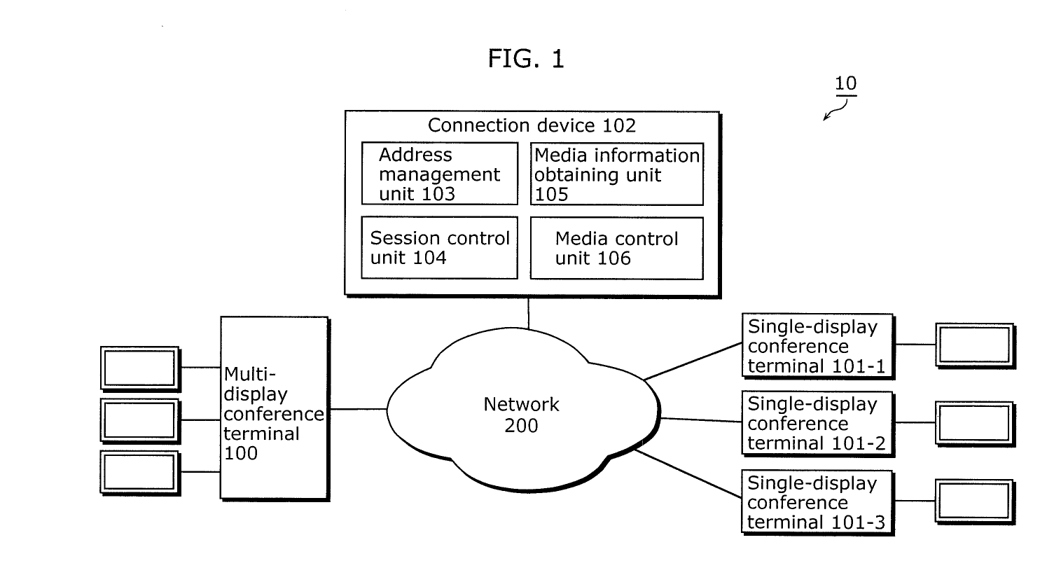

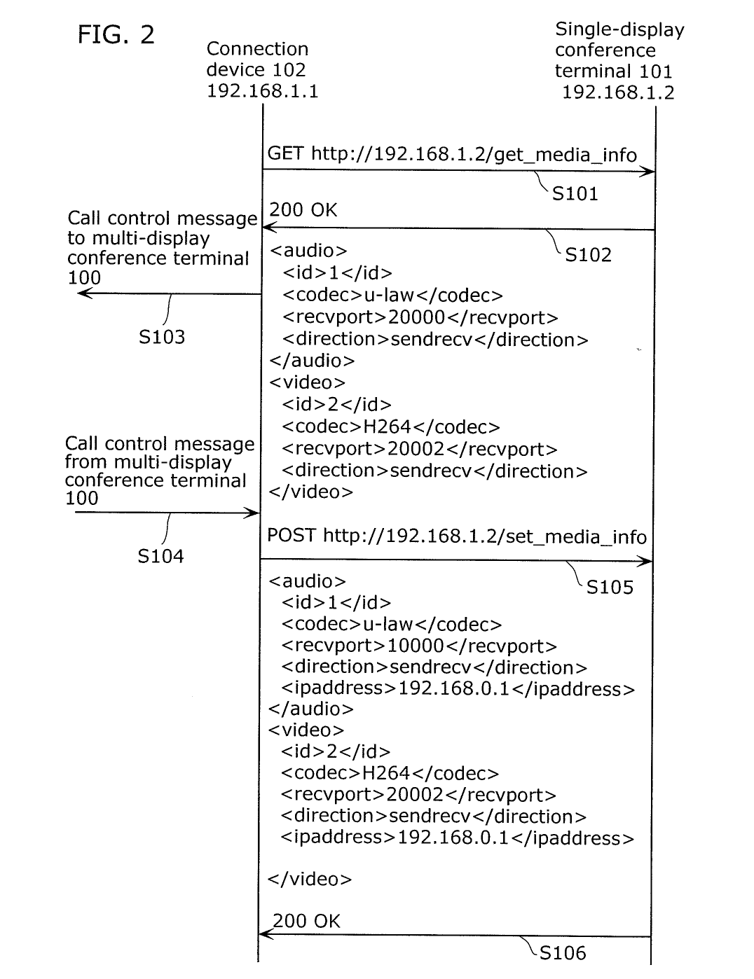

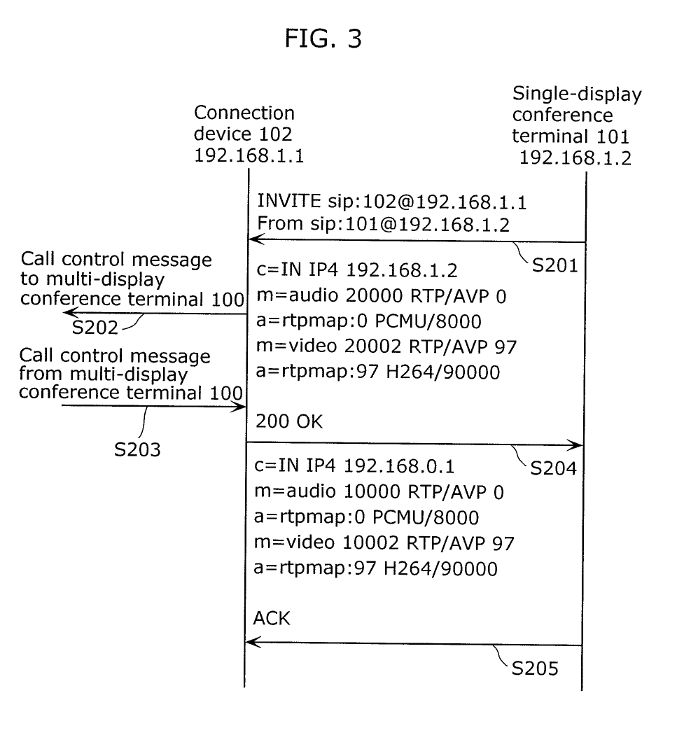

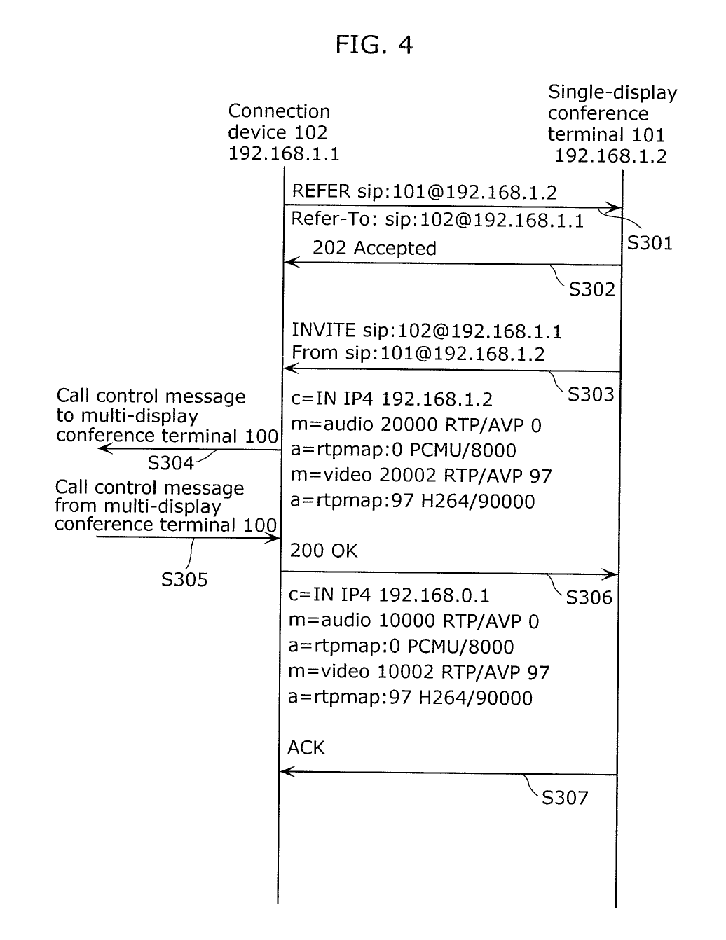

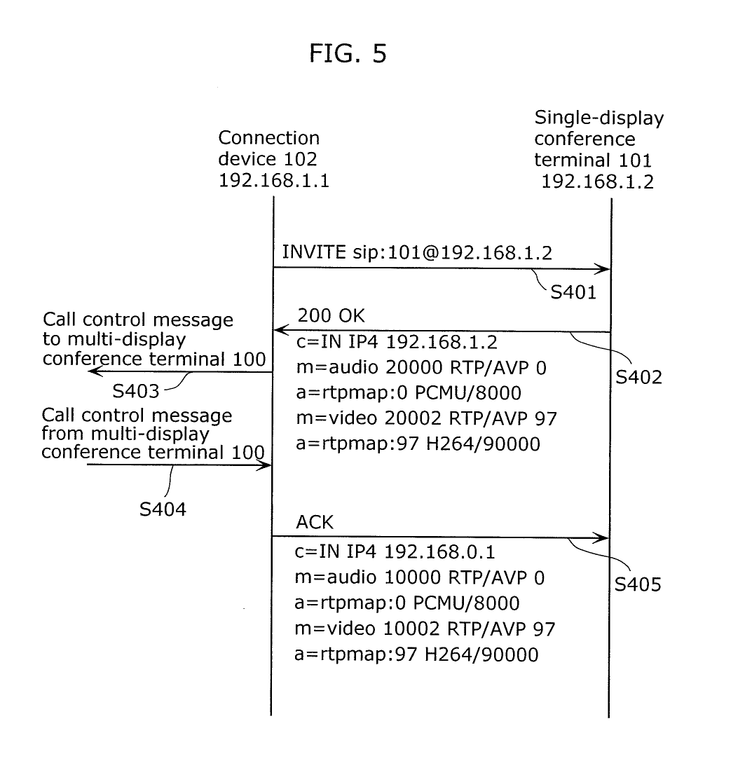

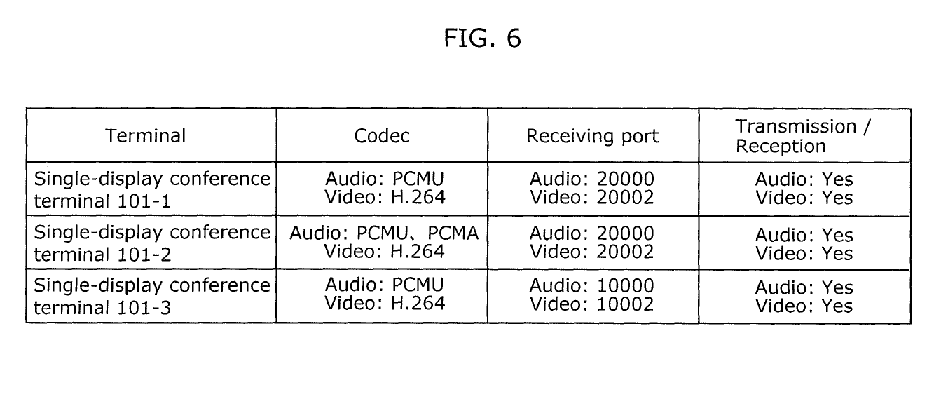

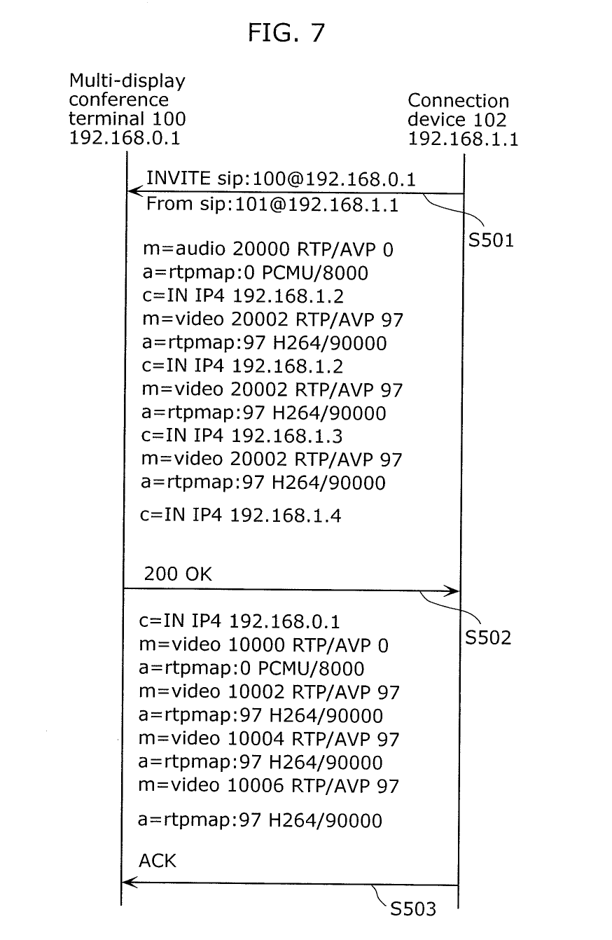

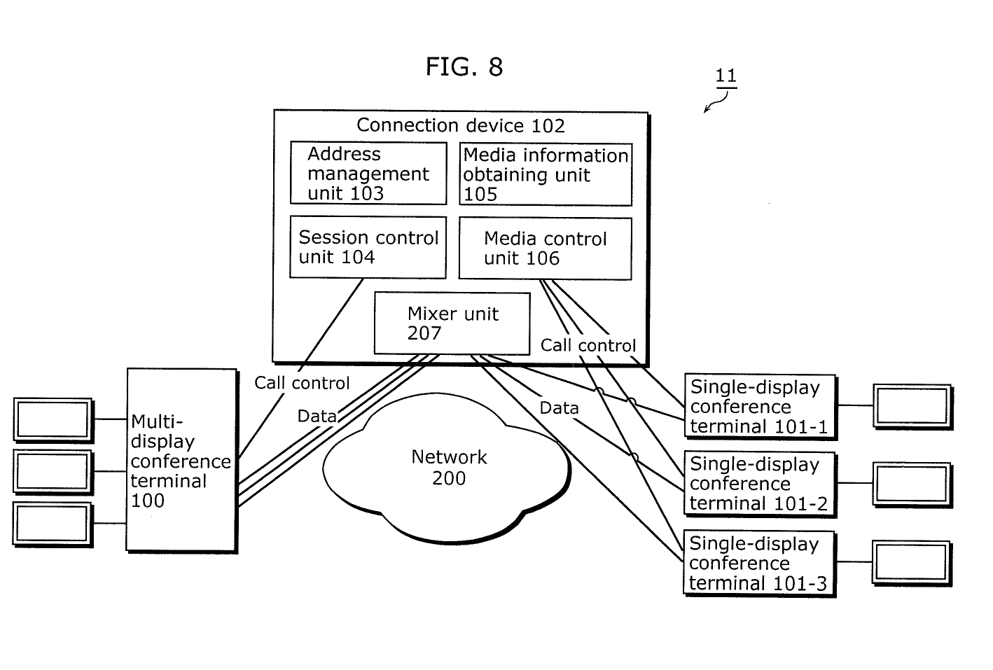

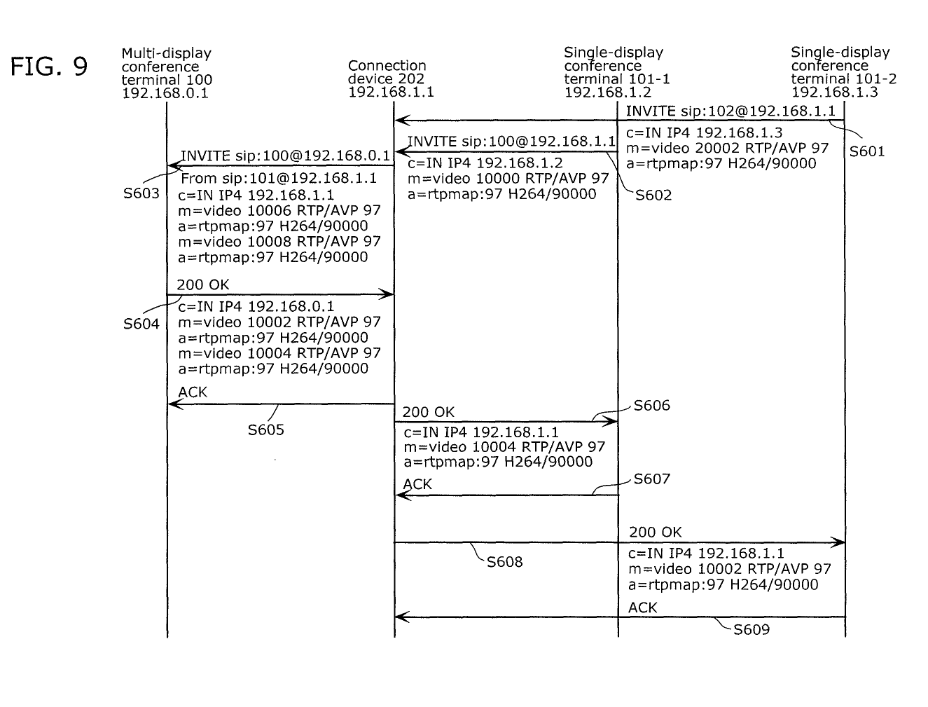

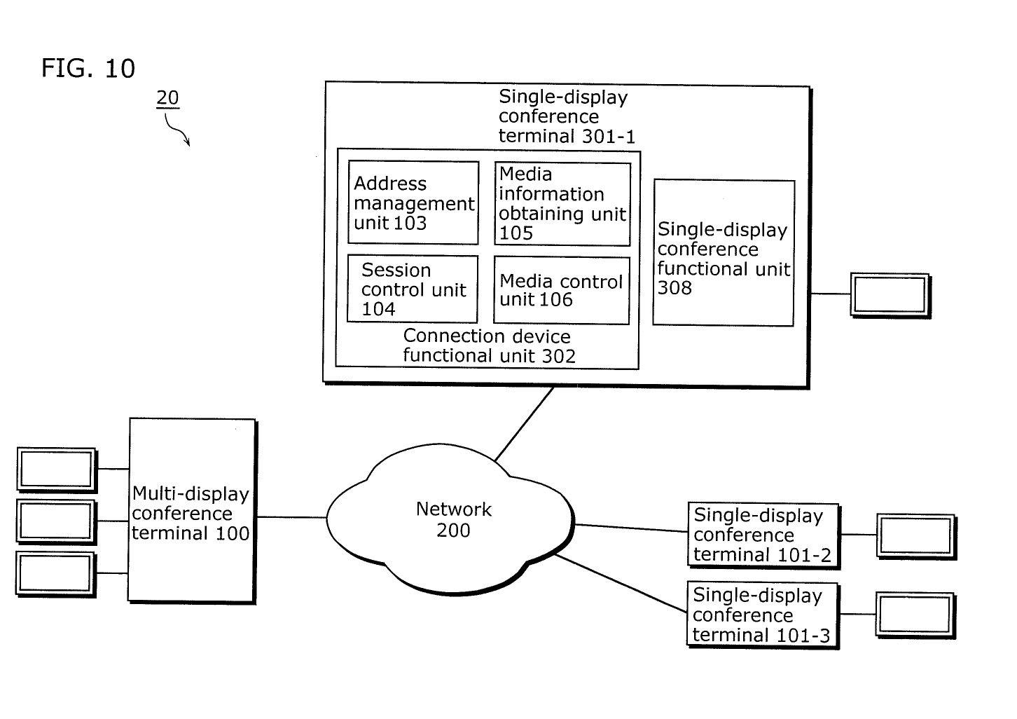

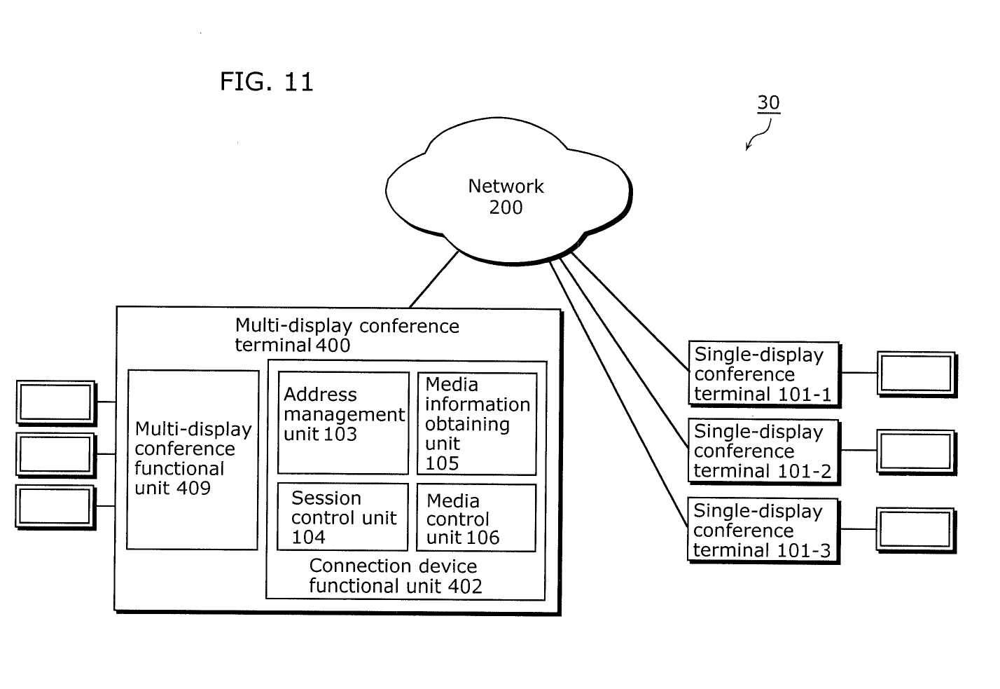

### BRIEF DESCRIPTION OF DRAWINGS

[FIG. 1] FIG. 1 illustrates an overview of a multi-screen conference system and a structure of the connection device according to a first embodiment of the present invention.

[FIG. 2] FIG. 2 is a flowchart illustrating a first method for obtaining media information and a media control method according to the first embodiment of the present invention.

[FIG. 3] FIG. 3 is a flowchart illustrating a second method for obtaining media information and a media control method according to the first embodiment of the present invention.

[FIG. 4] FIG. 4 is a flowchart illustrating a third method for obtaining media information and a media control method according to the first embodiment of the present invention.

[FIG. 5] FIG. 5 is a flowchart illustrating a fourth method for obtaining media information and a media control method according to the first embodiment of the present invention.

[FIG. 6] FIG. 6 is a diagram illustrating a fifth method for obtaining media information according to the first embodiment of the present invention.

[FIG. 7] FIG. 7 is a flowchart illustrating a method for controlling a session according to the first embodiment of the present invention.

[FIG. 8] FIG. 8 illustrates an overview of a multi-screen conference system and a structure of the connection device according to a second embodiment of the present invention.

[FIG. 9] FIG. 9 is a flowchart illustrating methods for obtaining media information, controlling media, and controlling a session according to the second embodiment of the present invention.

[FIG. 10] FIG. 10 illustrates an overview of a multi-screen conference system and a structure of the single-display conference terminal according to a third embodiment of the present invention.

[FIG. 11] FIG. 11 illustrates an overview of a multi-screen conference system and a structure of the multi-display conference terminal according to a fourth embodiment of the present invention.

[FIG. 12] FIG. 12 illustrates an example of flow of the call control message between the conference terminals when the SIP is used.

[FIG. 13] FIG. 13 illustrates an example of flow of the call control message between the conference terminals when the SIP is used.

[FIG. 14] FIG. 14 illustrates an example of connection example of the single-display terminal when holding a single-display video conference.

[FIG. 15] FIG. 15 illustrates an example of connection example of the multi-display conference terminal when holding a multi-screen video conference.

[FIG. 16] FIG. 16 illustrates an example of connection embodiment when holding multi-screen video conference using single-display conference terminals.

### REFERENCE SIGNS LIST

10, 11, 20, 30 Multi-screen conference system

100, 100-1 to 2, 400 Multi-display conference terminal

101, 101-1 to 6, 301-1 Single-display conference terminal

102, 202 Connection device

103 Address management unit

104 Session control unit

105 Media information obtaining unit

106 Media control unit

200 Network

207 Mixer unit

302, 402 Connection device functional unit

308 Single-display conference functional unit

409 Multi-display conference functional unit

801, 802, 901, 902 Conference terminal

### BEST MODE FOR CARRYING OUT THE INVENTION

The following describes embodiments of the present invention in detail with reference to the drawings. Note that the embodiments are embodied examples of the present invention, and do not limit the scope of the present invention.

### First Embodiment

FIG. 1 illustrates an overview of a multi-screen conference system 10 and the structure of a connection device 102 according to the first embodiment of the present invention.

In FIG. 1, a multi-display conference terminal 100, three single-display conference terminals 101 (101-1, 101-2, and 101-3) and the connection device 102 are connected via the network 200.

The network 200 is a public network such as the Internet or the phone network, a LAN, or an internal network, for example. The multi-display conference terminal 100, the single-display conference terminal 101 and the connection device 102 are connected via the network 200.

As described above, the multi-display conference terminal 100 is a conference terminal that can transmit and receive multiple videos, and can output the videos in multiple display areas. The display devices for displaying the received video data are connected to the multi-display conference terminal 100. In this example, three display devices are connected. Furthermore, the multi-display conference terminal 100 has an address on the network 200.

As described above, the single-display conference terminal 101 is a conference terminal that can transmit/receive one video, and can output the video on one display area. One display device (display) for displaying the received video data is connected to the single-display conference terminal 101. In addition, the single-display conference terminal 101 has an address on the network 200.

Note that, the conference terminals such as the single-display conference terminal 101 and the multi-display conference terminal 100 may be respectively integrated with the display device. In addition, the display device connected to the multi-display conference terminal 100 may physically be one display but may have divided display areas on the display.

Furthermore, though not illustrated, cameras each of which is for capturing the user using his conference terminal are connected to the multi-display conference terminal 100 and the single-display conference terminal 101, and the captured video is transmitted to the callee terminal.

In addition, though not illustrated, microphones and speakers each of which is for inputting/outputting audio data are connected to the multi-display conference terminal 100 and the single-display conference terminal 101. The multi-display conference terminal 100 and the single-display conference terminal 101 transmit the audio data inputted from the microphone to the callee terminal, and output the audio data received from the callee terminal from the speaker.

The connection device 102 relays the connection between the multi-display conference terminal 100 and the single-display conference terminal 101.

In addition, the connection device 102 has an address for call controlling on the network 200. For example, when the SIP is used, the connection device 102 has an address such as sip:102@example.com, and performs call control with the multi-display conference terminal 100.

As illustrated in FIG. 1, the connection device 102 includes the address management unit 103, the session control unit 104, the media information obtaining unit 105, and the media control unit 106.

The address management unit 103 manages the address of the single-display conference terminal 101 and the address of the connection device 102.

The session control unit 104 performs call control with the multi-display conference terminal 100 using the address of the connection device 102 managed by the address management unit 103 and the media information of the single-display conference terminal 101 obtained by the media information obtaining unit 105. The session control unit 104 subsequently obtains the media information that the multi-display conference terminal 100 can process, and establishes a session between the multi-display conference terminal 100 and the single-display conference terminal 101.

Here, establishing the session refers to the operation of calling the callee on the network 200 to enable the mutual communication of the audio data and the video data.

In addition, the media information is the information that the multi-display conference terminal 100, the single-display conference terminal 101 or the connection device 102 can process. The media information includes the type of codec, IP address, and the port number.

The media information obtaining unit 105 obtains the media information that the single-display conference terminal 101 can process. Furthermore, the media information obtaining unit 105 transmits/receives message to/from the single-display conference terminal 101.

The messages to be transmitted/received include a session starting message from the single-display conference terminal 101, a message requesting the single-display conference terminal 101 to send the session starting message, a response message from the single-display conference terminal 101 and others, for example.

In addition, methods for the media information obtaining unit 105 to obtain the media information that the single-display conference terminal 101 can process includes the methods by HTTP and SIP, for example. The specific example using HTTP and SIP is to be described later and thus is omitted here; however, it should be noted that protocols with equivalent function can be used as well.

Note that, the media information obtaining unit 105 may hold the media information that the single-display conference terminal 101 can process as a database in advance.

The media control unit 106 notifies the single-display conference terminal 101 of the media information obtained by the session control unit 104 and that the multi-display conference terminal 100 can process. In addition, the media control unit 106 controls transmission/reception of media. In other words, the media control unit 106 instructs the multi-display conference terminal 100 and the single-display conference terminal 101 to start transmission/reception of data between the multi-display conference terminal 100 and the single-display conference terminal 101.

Note that, the single-display conference terminal 101 has an address on the network 200. This address may be an address that can be used for obtaining the media information of the single-display conference terminal 101 by the media information obtaining unit 105 and for the media transmission/reception control of the single-display conference terminal 101 by the media control unit 106. For example, the address may not be a call control address determined by the SIP or H.323. In addition, this address may be an address such as http://101-a.example.com/, for example, when HTTP is used for obtaining media information and controlling media transmission/reception.

The following describes a specific example of the case where the media information is obtained using HTTP or SIP and a session is established.

FIG. 2 is a flowchart illustrating a first method for obtaining media information and a media control method according to the first embodiment of the present invention.

FIG. 2 illustrates a method when the HTTP protocol is used.

First, the media information obtaining unit 105 in the connection device 102 creates a URL for obtaining media information from the address that is held in advance or the address obtained from the address management unit 103 for obtaining the media information that the single-display conference terminal 101 can process. For example, the URL for obtaining the media information is URL http://192.168.1.2/get_media_info. The media information obtaining unit 105 subsequently transmits the HTTP GET request in response to the created URL (S101).

Next, when the HTTP GET request is received, the single-display conference terminal 101 transmits a “200 OK” message in response to the HTTP GET request (S102).

In the example in FIG. 2, the single-display conference terminal 101 includes the information indicating that the codec u-law and the receiving port 20000 can be transmitted/received as the audio data in the “200 OK” message and transmits the message. In addition, other parameters may also be included in the “200 OK” message.

Note that, the conference terminal generally includes a web console for management; it is usually possible to specify the codec or the port number to be used from the web console. Thus, the single-display conference terminal 101 which is a general conference terminal can usually obtain the media information without special extension.

In addition, the media information obtaining unit 105 performs the same operation on the other single-display conference terminals 101 based on the address information and others of the single-display conference terminal 101 managed by the address management unit 103.

Next, the session control unit 104 transmits a call-control message to the multi-display conference terminal 100 (S103).

The session control unit 104 then receives a call-control message from the multi-display conference terminal 100 (S104). The session control unit 104 obtains the media information that that multi-display conference terminal 100 can process from the received call control message.

Next, the media control unit 106 creates a URL for setting the media information of the single-display conference terminal 101 from the address that is held in advance or the address obtained from the address management unit 103. For example, the URL for obtaining the media information is URL http://192.168.1.2/set_media_info. The media control unit 106 subsequently transmits the HTTP POST request to the created URL (S105). The media information of the multi-display conference terminal 100 obtained by the session control unit 104 is set in the HTTP POST request.

Next, when the HTTP POST request is received, the single-display conference terminal 101 transmits a “200 OK” message in response to the HTTP POST request (S106).

Note that, no particular additional process is necessary if transmission/reception of the data automatically start when the media information of the multi-display conference terminal 100 and the single-display conference terminal 101 is set. Otherwise, the media control unit 106 may further access a URL indicating the start of transmission and reception, and instructs the start of the data transmission/reception.

The media control unit 106 further performs the same process on the single-display conference terminals 101 based on the address information of the single-display conference terminals managed by the address management unit 103.

As such, after the session is established between the multi-display conference terminal 100 and the single-display conference terminal 101, transmission/reception of the audio data and the video data start between the multi-display conference terminal 100 and the single-display conference terminal 101.

FIG. 3 is a flowchart illustrating a second method for obtaining media information and a media control method according to the first embodiment of the present invention.

FIG. 3 illustrates a method for originating the transmission from the single-display conference terminal 101 side when the SIP protocol is used.

First, the single-display conference terminal 101 transmits an “INVITE” message to the connection device 102 through the control of the single-display conference terminal 101 by the user (S201).

In the example in FIG. 3, in the message body of the “INVITE” message, the audio code PCMU (u-law), the port number 20000, the video codec H.264 and the port number 2002 that are available to the single-display conference terminals 101 are set.

In addition, as described above, the message body is described in SDP which is a format for describing the content of the multimedia session. In SDP the default setting is capable of transmitting and receiving, and thus it is possible to transmit and receive audio data and video data. Here, the default setting refers to the pre-installed setting which is used when the user does not perform any operation or setting.

Next, the session control unit 104 transmits a call-control message to the multi-display conference terminal 100 (S202).

The session control unit 104 then receives a call-control message from the multi-display conference terminal 100 (S203). The session control unit 104 obtains the media information that that multi-display conference terminal 100 can process from the received call control message.

Next, the media control unit 106 in the connection device 102 transmits the “200 OK” message to the single-display conference terminal 101 as a response message (S204).

In the example of FIG. 3, the “200 OK” response message sets the obtained media information of the multi-display conference terminal 100, and the single-display conference terminal 101 is notified of the media information that the multi-display conference terminal 100 can process.

When the “200 OK” message is received, the single-display conference terminal 101 transmits, to the connection device 102, the “ACK” message notifying the connection device 102 that the session is established (S205).

The single-display conference terminal 101 subsequently starts transmitting/receiving data.

The “200 OK” message and the response “ACK” message indicate that the session is established. Thus, the connection device 102 can simultaneously notify the media information and control the data transmission/reception by the “200 OK” message.

Note that, the media information obtaining unit 105 performs the same process on the single-display conference terminals 101 based on the address information of the single-display conference terminals 101 managed by the address management unit 103.

Note that, a temporary address or holding may be set to the “ACK” message when the call control between the connection device 102 and the multi-display conference terminal 100 takes time. That is, the connection device 102 establishes a session between the multi-display conference terminal 100 and the single-display conference terminal 101. However, the connection device 102 may be set to instruct the single-display conference terminal 101 not to transmit/receive the data from the single-display conference terminal 101. Here, the connection device 102 may transmit the “UPDATE” message or the “re-INVITE” message to the single-display conference terminal 101 after the call control message from the multi-display conference terminal 100 is received. With this, the connection device 102 can notify the single-display conference terminal of the media information that the multi-display conference terminal 100 can process while instructing the start of the data transmission/reception between the multi-display conference terminal 100 and the single-display conference terminal 101.

As such, after the session is established between the multi-display conference terminal 100 and the single-display conference terminal 101, transmission/reception of the audio data and the video data start between the multi-display conference terminal 100 and the single-display conference terminal 101.

FIG. 4 is a flowchart illustrating a third method for obtaining media information and a media control method according to the first embodiment of the present invention.

FIG. 4 illustrates a method for sending a request message for originating the transmission from the single-display conference terminal 101 when the SIP protocol is used.

First, the connection device 102 transmits, to the single-display conference terminal 101, the “REFER” message that sets the address information of the connection device 102 on the Refer-To header (S301).

Here, the “REFER” message is an SIP message requesting a conference terminal to transmit the “INVITE” message to the destination specified in the Refer-To header.

When the “REFER” message is received, the single-display conference terminal 101 transmits the “202 Accepted” message to the connection device 102 in response to the “REFER” message (S302).

The single-display conference terminal 101 subsequently transmits the “INVITE” message to the connection device 102 (S303). Here, the operation in S301 is similar to S202 in FIG. 3.

The session control unit 104 then transmits a call-control message to the multi-display conference terminal 100 (S304), and receives a call-control message from the multi-display conference terminal 100 (S305). The session control unit 104 obtains the media information that multi-display conference terminal 100 can process from the received call control message. Description for subsequent process (S306 and S307) is omitted, since it is similar to the process in FIG. 3 described above.

As such, after the session is established between the multi-display conference terminal 100 and the single-display conference terminal 101, transmission/reception of the audio data and the video data start between the multi-display conference terminal 100 and the single-display conference terminal 101.

FIG. 5 is a flowchart illustrating a fourth method for obtaining media information and a media control method according to the first embodiment of the present invention.

FIG. 5 illustrates a method of originating transmission from the connection device 102 side when the SIP protocol is used.

First, the connection device 102 transmits an “INVITE” message to the single-display conference terminal 101 (S401).

In the example of FIG. 5, the “INVITE” message does not include the media information of the multi-display conference terminal 100. The media information that the single-display conference terminal 101 can process is received by the response from the single-display conference terminal 101.

When the “INVITE” message is received, the single-display conference terminal 101 subsequently transmits the “200 OK” message in response to the “INVITE” message (S402).

In the example in FIG. 5, the single-display conference terminal 101 includes, in the response, the media information that the single-display conference terminal 101 can process and send the response.

Next, the session control unit 104 transmits a call-control message to the multi-display conference terminal 100 (S403).

The session control unit 104 then receives a call-control message from the multi-display conference terminal 100 (S404). The session control unit 104 obtains the media information that multi-display conference terminal 100 can process from the received call control message.

Next, the connection device 102 transmits the “ACK” message notifying the single-display conference terminal 101 that the session is established to the single-display conference terminal 101 (S405). The “ACK” message includes the received media information of the multi-display conference terminal 100.

As such, after the session is established between the multi-display conference terminal 100 and the single-display conference terminal 101, transmission/reception of the audio data and the video data start between the multi-display conference terminal 100 and the single-display conference terminal 101.

Note that, a temporary address or holding may be set in the “ACK” message when the call control between the connection device 102 and the multi-display conference terminal 100 takes time. That is, the connection device 102 establishes a session between the multi-display conference terminal 100 and the single-display conference terminal 101. However, the connection device 102 instructs the single-display conference terminal 101 not to transmit/receive the data to/from the single-display conference terminal 101. The connection device 102 transmits the “UPDATE” message or the “re-INVITE” message to the single-display conference terminal 101 after the call control message from the multi-display conference terminal 100 is received. With this, the connection device 102 can instruct the start of the transmission/reception of the data between the multi-display conference terminal 100 and the single-display conference terminal 101 while notifying the media information that the multi-display conference terminal 100 can process.

FIG. 6 is a diagram illustrating the fifth method for obtaining the media information according to the first embodiment of the present invention.

As illustrated in FIG. 6, the media information obtaining unit 105 may hold the media information that the single-display conference terminal 101 can process as a database in advance. FIG. 6 illustrates that the information indicating whether or not the type of codec, the receiving port number, the audio data or the video data can be transmitted/received is held as the media information of the single-display conference terminals 101-1, 101-2, and 101-3.

In this case, using the Web interface and others illustrated in FIG. 2 performs media control such as notifying the media information of the multi-display conference terminal 100, starting or stopping the transmission/reception of the audio data and the video data.

FIG. 7 is a flowchart illustrating the session control method according to the first embodiment of the present invention. FIG. 7 illustrates the flow of the call control message between the connection device 102 and the multi-display conference terminal 100.

First, the connection device 102 transmits the “INVITE” message to the multi-display conference terminal 100 (S501).

In the example of FIG. 7, the connection device 102 sets the address information of the connection device 102 in the From header, when transmitting the “INVITE” message. The connection device 102 further constructs the SDP in the message body of the “INVITE” message, based on the media information obtained from the three single-display conference terminals 101 (101-1, 101-2, and 101-3).

In the example illustrated in FIG. 7, only one single-display conference terminal 101 (for example, the single-display conference terminal 101-1, whose IP address is 192.168.1.2) is used among the three single-display conference terminals 101 (101-1, 101-2, and 101-3). In addition, the video data specifies that the three single-display conference terminals 101 shall be used. The specified single-display conference terminals 101 include, for example, the single-display conference terminals 101-1 to 101-3 whose IP addresses are 192.168.1.2, 192.168.1.3, and 192.168.1.4.

Note that, the audio data may use three single-display conference terminals 101 (101-1, 101-2, and 101-3).

The multi-display conference terminal 100 transmits the “200 OK” message as a response to the “INVITE” message (S502).

In the example illustrated in FIG. 7, the multi-display conference terminal 100 specifies, with regard to the audio data and the video data specified by the “INVITE” message, to receive the audio data using the codec PCMU and the port 10000. In addition, the multi-display conference terminal 100 specifies that the three video media is received in the codec H.264 and the port 10002, in the codec H.264 and the port 10004, and in the codec H.264 and the port 10006.

Next, the connection device 102 receives the 200 response message, and obtains the media information that the multi-display conference terminal 100 can process. When the “200 OK” message is received, the connection device 102 transmits the “ACK” message to the multi-display conference terminal 100 (S503).

As such, after the session is established between the multi-display conference terminal 100 and the single-display conference terminal 101, transmission/reception of the audio data and the video data start between the multi-display conference terminal 100 and the single-display conference terminal 101.

Note that, FIG. 7 describes a case where the transmission originates from the connection device 102 to the multi-display conference terminal 100. However, the transmission may originate from the multi-display conference terminal 100 to the connection device 102. In this case, the multi-display conference terminal 100 first transmits the “INVITE” message to the connection device 102. Subsequently, the connection device 102 obtains the media information of the single-display conference terminal 101 by the media information obtaining unit 105 in advance or at the timing when the “INVITE” message is received. Subsequently, the connection device 102 may transmit the response message of the “200 OK” to the multi-display conference terminal 100, using the obtained media information of the single-display conference terminal 101.

Furthermore, either or both of the media information obtaining unit 105 and the media control unit 106 which transmit/receive the message to/from the single-display conference terminal 101 may recognize and manage the type of the conference terminals for each of the single-display conference terminals 101. In this case, selecting the method for each type of the terminals and adjusting the details allow such management. Here, the types of the conference terminals include the manufacturer and the model of the product. The single-display conference terminal 101 may be recognized by referring to the value of the User-Agent header in the SIP message. More specifically, defining the format for each the type and product model of the single-display conference terminal 101 allows recognizing and managing the type of each of the single-display conference terminals 101. This allows switching and slightly adjusting the control method for each of the single-display conference terminals 101.

As described above, the first embodiment of the present invention implements the connection device 102 that interconnects the multi-display conference terminal 100 and the single-display conference terminals 101 through the processes by the address management unit 103, the session control unit 104, the media information obtaining unit 105, and the media control unit 106.

In addition, according to the connection device 102 in the first embodiment of the present invention, call control can be performed using the media information including the entire media information that the single-display conference terminal 101 can process. This allows transmitting/receiving multiple data between the multi-display conference terminal 100 and multiple single-display conference terminals 101.

In addition, the user may operate the connection device 102 for interconnecting the multi-display conference terminal 100 and the multiple single-display conference terminals 101. Thus, the complexity in operating the multiple single-display conference terminals 101 is solved.

In addition, according to the connection device 102 in the first embodiment of the present invention, it is possible to connect the single-display conference terminal 101 using the SIP as the call-control protocol and the single-display conference terminal 101 using H.323 as the call control protocol can be connected to the multi-display conference terminal 100 together. Furthermore, the connection device 102 enables the connections of the single-display conference terminals 101 which use the same call control protocol but are different in versions or the protocols by the manufacturer of the conference terminal to connect with the multi-display conference terminal 100.

As described above, it is possible to implement the connection device and the connection method that (i) can establish a connection for transmitting and receiving video data through a network between a single-display conference terminal which receives an item of video data and outputs the video data to one display area and a multi-display conference terminal which receives at least two items of video data and outputs the at least two items of video data to display areas, (ii) does not require the user to perform complicated operation, and (iii) can interconnect the single-display conference terminal and the multi-display conference terminal.

### Second Embodiment

In the first embodiment, an example where the multi-display conference terminal 100 and multiple single-display conference terminals 101 are interconnected through bundling, by the connection device 102, multiple single-display conference terminals 101. The second embodiment describes an example where the connection device 102 is further capable of converting media.

FIG. 8 illustrates an overview of a multi-screen conference system 11 and a connection device 202 according to the second embodiment of the present invention. The same reference numerals are attached to the components similar to FIG. 1. Thus, detailed explanation is omitted.

The connection device 202 includes an address management unit 103, a session control unit 104, a media information obtaining unit 105, a media control unit 106, and a mixer unit 207. The connection device 202 illustrated in FIG. 8 differs from the connection device 102 according to the first embodiment, in the structure of the mixer unit 207.

The mixer unit 207 receives the data from the multi-display conference terminal 100 and the single-display conference terminal 101, and converts the received data. After that, the mixer unit 207 transmits the converted data to the single-display conference terminal 101 and the multi-display conference terminal 100.

The data here refers to audio data or video data.

As illustrated in FIG. 8, the multi-display conference terminal 100 transmits/receives the data with the mixer unit 207. The single-display conference terminal 101 transmits/receives data with the mixer unit 207. Put differently, the multi-display conference terminal 100 and the single-display conference terminal 101 transmits/receives data via the mixer unit 207.

FIG. 9 is a flowchart illustrating the media information obtaining method; the media control method, and the session control method according to the second embodiment of the present invention.

FIG. 9 illustrates an example of the multi-display conference terminal 100 transmitting/receiving two video data.

First, each of the two single-display conference terminals 101 (101-1 and 101-2) transmits an “INVITE” message to the connection device 202 (S601 and S602). Here, the “INVITE” message transmitted by the two single-display conference terminals 101 (101-1 and 101-2) includes the media information that each of the single-display conference terminals 101 (101-1 and 101-2) can process.

Next, the connection device 202 transmits an “INVITE” message to the multi-display conference terminal 100 to establish a session with the multi-display conference terminal 100.

Here, the information obtained by converting the media information received from the single-display conference terminal 101 into the media information that the mixer unit 207 can receive is set in the “INVITE” message. FIG. 9 illustrates an example in which the receiving IP address and the port number are converted to the IP address and port number that the mixer unit 207 can receive, although the codec remains the same.

The multi-display conference terminal 100 then transmits the “200 OK” message in response to the “INVITE” message (S604).

The connection device 202 then receives the “200 OK” response message from the multi-display conference terminal 100, and transmits “ACK” message notifying that the session with the multi-display conference terminal 100 is established to the multi-display conference terminal 100 (S605).

The connection device 202 obtains the media information that the multi-display conference terminal 100 can receive, from the response message received from the multi-display conference terminal 100. The connection device 202 then transmits a “200 OK” response message to the single-display conference terminal 101-1, as a response to the “INVITE” message from the single-display conference terminal 101-1, for example (S606).

Here, the response message to the “200 OK” message includes the information which is obtained by converting the media information received from the multi-display conference terminal 100 to the media information that the mixer unit 207 can receive. FIG. 9 illustrates an example in which the receiving IP address and the port number are converted to the IP address and port number that the mixer unit 207 can receive, although the codec remains the same.

Next, the single-display conference terminal 101-1 transmits an “ACK” message notifying that the session with the connection device 202 is established to the connection device 202 (S607).

The connection device 202 then transmits a “200 OK” response message to the single-display conference terminal 101-2, in response to the “INVITE” message from the single-display conference terminal 101-2, for example (S607). Here, in the same manner as S606, the response message to the “200 OK” to the single-display conference terminal 101-2 includes the information obtained by converting the media information received from the multi-display conference terminal 100 into the media information that the mixer unit 207 can receive.

Next, the single-display conference terminal 101-2 transmits an “ACK” message notifying that the session with the connection device 202 is established to the connection device 202 (S609).

As such, after the session is established between the multi-display conference terminal 100 and the single-display conference terminal 101, transmission/reception of the audio data and the video data start between the multi-display conference terminal 100 and the single-display conference terminal 101.

As described above, it becomes possible to implement a connection device and a connection method that allows an interconnection between the single-display conference terminal and the multi-display conference terminal using multiple videos without complicated operation by the user.

Note that, although the mixer unit 207 is included in the same device as the connection device 202, the mixer unit 207 may be implemented as a separate device.

In addition, the connection device 202 may transmit/receive a part of data processed by the multi-display conference terminal 100 with the single-display conference terminal 101 via the mixer unit 207.

Furthermore, according to the connection device 102 according to the second embodiment of the present invention, providing the mixer unit 207 increases the flexibility and convenience of the multi-screen conference system structure. For example, the mixer unit 207 can sync multiple audio data or can synthesize one audio data from multiple audio data, when transmitting/receiving multiple audio data between the single-display conference terminal 101 and the multi-display conference terminal 100. Furthermore, a connection can be established even when the codec supported by the multi-display conference terminal 100 is not supported by the single-display conference terminal 101.

### Third Embodiment

The first embodiment describes a case where the connection device 102 is independent from the multiple single-display conference terminals 101 and the multi-display conference terminal 100. The third embodiment describes an example in which the function of the connection device 102 is embedded to the single-display conference terminal 301-1.

FIG. 10 illustrates an overview of a multi-screen conference system 20 and a structure of a single-display conference terminal 301-1 according to the third embodiment of the present invention. The same reference numerals are attached to the components similar to FIG. 1. Thus, detailed explanation is omitted.

The single-display conference terminal 301-1 includes a connection device functional unit 302 and a single-display conference functional unit 308.

The connection device functional unit 302 includes the address management unit 103, the session control unit 104, the media information obtaining unit 105, and the media control unit 106, and is capable of implementing the connection device 102 according to the first embodiment.

The single-display conference terminal functional unit 308 implements the function of the single-display conference terminal 101. More specifically, the single-display conference terminal 301-1 maintains all of the original function of the single-display conference terminal 101. The single-display conference terminal 301-1 further includes the address management unit 103, the session control unit 104, the media information obtaining unit 105, and the media control unit 106 which implement the function of the connection device 102.

The single-display conference terminal 301-1 has the function of the connection device 102. Thus, the single-display conference terminal 301-1 can connect with the multi-display conference terminal 100 and the single-display conference terminals 101 (101-2 and 101-3). The single-display conference terminal 301-1 can further connect with the other single-display conference terminals which have the function of the connection device 102.

Thus, the single-display conference terminal 301-1 which has the function of the connection device 102 can hold multi-screen conference using one or more display with the single-display conference terminal 301-1 only. For example, only one single-display conference terminal 301-1 is introduced when the multi-screen conference system 20 is first installed, and it is possible to gradually construct the multi-screen conference system 20 by increasing the number of the single-display conference terminal 101. In other words, it is effective for promoting a migration in which the single-display conference terminal 101 and the multi-display conference terminal 100 are used together, and the multi-display conference terminal 100 gradually replaces the single-display conference terminal 101.

### Fourth Embodiment

The third embodiment described an example in which the function of the connection device 102 is embedded to the single-display conference terminal 301-1. The fourth embodiment describes a case where the function of the connection device 102 is embedded to the multi-display conference terminal 400.

FIG. 11 illustrates an overview of a multi-screen conference system 30 and a structure of a multi-display conference terminal 400 according to the fourth embodiment of the present invention. The same reference numerals are attached to the components similar to FIG. 1. Thus, detailed explanation is omitted.

The multi-display conference terminal 400 includes a connection device functional unit 402 and a multi-display conference functional unit 409.

The connection device functional unit 402 includes the address management unit 103, the session control unit 104, the media information obtaining unit 105, and the media control unit 106, and is capable of implementing the connection device 102 according to the first embodiment.

The multi-display conference functional unit 409 implements the function of the multi-display conference terminal 100.

The multi-display conference terminal 400 maintains all of the original multi-display conference function of the multi-display conference terminal 100. Furthermore, the multi-display conference terminal 400 embedded with the address management unit 103, the session control unit 104, the media information obtaining unit 105, and the media control unit 106, which implement the function of the connection device 102.

The multi-display conference terminal 400 has the function of the connection device 102. Thus, the multi-display conference terminal 400 can be connected to the multiple single-display conference terminals 101 (101-1, 101-2, and 101-3). In addition, the multi-display conference terminal 400 can establish multiple call-control sessions with the multiple multi-display conference terminals 100, that is, establish a call-control session for each media for connection.

Thus, by using this function, the multi-display conference terminal 400 can connect to multiple multi-display conference terminals 100 using a network service for a conference using only one screen.

In addition, only multi-display conference terminal 400 is introduced when the multi-screen conference system 30 is first installed, and gradually introduce the multi-display conference terminal 100, it is possible to effectively use the existing single-display conference terminal 101. In other words, it is effective for promoting a migration in which the single-display conference terminal 101 and the multi-display conference terminal 100 are used together, and the multi-display conference terminal 100 gradually replaces the single-display conference terminal 101.

As described above, the present invention can implement a connection device that can interconnect the single-display conference terminals and the multi-display conference terminal without complicated operation by the user, by managing and controlling multiple single-display conference terminals in a bundle and performing a call-control with the multi-display conference terminal.

Although only some exemplary embodiments of the connection device and the conference terminal with the connection device function according to the invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a connection device which connects a single-display conference terminal and the multi-display conference terminal. Particularly, the present invention is applicable to a connection device which connects the conference terminals used for a telepresence system and a multi-screen video conference system.

1. A connection device which establishes a connection for transmitting and receiving video data through a network between a single-display conference terminal which receives an item of video data and outputs the video data to one display area and a multi-display conference terminal which receives at least two items of video data and outputs the at least two items of video data to display areas, said connection device comprising:
an address holding unit configured to hold address information indicating an address, on the network, of each of single-display conference terminals and address information indicating an address, on the network, of said connection device;
a media information obtaining unit configured to obtain information related to media that each of the single-display conference terminals can process, and to hold the entire obtained information as first media information;
a session control unit configured to establish a session with the multi-display conference terminal using the address information of said connection device and the first media information obtained by said media information obtaining unit, while obtaining second media information related to media that the multi-display conference terminal can process; and
a media control unit configured to establish a session with the single-display conference terminals using the second media information obtained by said session control unit and to control the single-display conference terminals to transmit and receive data.

2. The connection device according to claim 1,
wherein said media information obtaining unit is configured to receive, from the single-display terminal, a session starting message including a request for starting the session, and to obtain the first media information from the received session starting message.

3. The connection device according to claim 2,
wherein said media control unit is configured to instruct the single-display conference terminal to start transmitting and receiving the data in the single-display conference terminal by transmitting a response message in response to the session starting message to the single-display conference terminal.

4. The connection device according to claim 3,
wherein said media information obtaining unit is configured to transmit, to the single-display conference terminal, an instruction message instructing the single-display conference terminal to transmit the session starting message to the connection device.

5. The connection device according to claim 1,
wherein said media information obtaining unit is configured to transmit, to the single-display conference terminal, a session starting message which does not include the second media information and is a request message for starting the session, to receive a response message to the session starting message from the single-display conference terminal, and to obtain the first media information from the response message.

6. The connection device according to claim 5,
wherein said media control unit is configured to establish the session by transmitting a confirmation message including the second media information in response to the response message to the single display conference terminal, and to instruct the single-display conference terminal to start transmitting and receiving the data in the single-display conference terminal.

7. The connection device according to claim 1, further comprising
a storage unit configured to hold the first media information,
wherein said media information obtaining unit is configured to obtain the first information from said storage unit.

8. The connection device according to claim 1,
wherein said media information obtaining unit is configured to recognize a type of each of the single-display conference terminals, and to adjust a message transmitted to and received from each of the single-display conference terminals according to recognized types.

9. The connection device according to claim 8,
wherein said media control unit is configured to recognize the types and to adjust messages each of which is transmitted to and received from each of the single-display conference terminals according to the type.

10. The connection device according to claim 1,
wherein the first media information includes a type of codec, an IP address and a port number that the single-display conference terminal can receive, and
the second media information includes a codec type, an IP address, and a port number that the multi-display conference terminal can receive.

11. The connection device according to claim 1, further comprising
a mixer unit configured to receive media from the single-display conference terminal or the multi-display conference terminal, to convert the received data, and to transmit the converted data to the multi-display conference terminal or the single-display conference terminal,
wherein said session control unit is configured to convert the first media information obtained by said media information obtaining unit into third media information related to media that said mixer unit can process, and to use the third media information to establish a session with the multi-display conference terminal instead of the first media information, and
said media control unit is configured to establish the session with the single-display conference terminal using the third media information instead of the first media information, to transmit and to receive data to and from the single-display conference terminals and the multi-display conference terminal through said mixer unit.

12. The connection device according to claim 1,
wherein said session control unit is configured to use the first media information without any modification to establish the session with the multi-display conference terminal,
said media control unit is configured to use the second information without any modification for establishing the session with the single-display conference terminal, and
the single-display conference terminals transmit and receive data based on the second media information, and the multi-display conference terminal transmits and receives data based on the first media information.

13. A single-display conference terminal which receives an item of video data and outputs the video data to one display area, said single display conference terminal comprising
said connection device according to claim 1.

14. A multi-display conference terminal which receives at least two items of video data and outputs the received at least two items of video data to display areas, said multi-display conference terminal comprising
said connection device according to claim 1.

15. A connection device which establishes a connection for transmitting and receiving video data through a network, between a single-display conference terminal which receives an item of video data and outputs the video data to one display area and a multi-display conference terminal which receives at least two items of video data and outputs the at least two items of video data to display areas, said connection device comprising:
a media information obtaining unit configured to obtain information related to media that each of single-display conference terminals can process, and to hold the entire obtained information;
a session control unit configured to establish a session with the multi-display conference terminal using the entire obtained information held by said media information obtaining unit; and
a media control unit configured to establish a session between the multi-display conference terminal and the single-display conference terminal by establishing a session with the single-display conference terminals after said session control unit establishes a session with the multi-display conference terminal, and to instruct the multi-display conference terminal and the single-display conference terminals to start transmitting and receiving data.

16. A connection method for a connection device which establishes a connection for transmitting and receiving video data through a network between a single-display conference terminal which receives an item of video data and outputs the video data to one display area and a multi-display conference terminal which receives at least two items of video data and outputs the at least two items of video data to display areas, said connection method comprising:
holding address information indicating an address, on the network, of each of single-display conference terminals and address information indicating an address, on the network, of said connection device;
obtaining information related to media that each of the single-display conference terminals can process, and holding the entire obtained information as first media information;
establishing a session with the multi-display conference terminal using the address information of said connection device and the first media information obtained in said obtaining while obtaining second media information related to media that the multi-display conference terminal can process; and
establishing a session with the single-display conference terminals using the second media information obtained by said session control unit and controlling the single-display conference terminals to transmit and receive data.

17. An integrated circuit which establishes a connection for transmitting and receiving video data through a network between a single-display conference terminal which receives an item of video data and outputs the video data to one display area and a multi-display conference terminal which receives at least two items of video data and outputs the at least two items of video data to display areas, said integrated circuit comprising:
an address holding circuit configured to hold address information indicating an address, on the network, of each of single-display conference terminals and address, information indicating an address, on the network, of said integrated circuit;
a media information obtaining unit configured to obtain information related to media that each of the single-display conference terminals can process, and to hold the entire obtained information as first media information;
a session control circuit configured to establish a session with the multi-display conference terminal using the address information of said integrated circuit and the first media information obtained by said media information obtaining circuit while obtaining second media information related to media that the multi-display conference terminal can process; and
a media control circuit configured to establish a session with the single-display conference terminals using the second media information obtained by said session control circuit and control the single-display conference terminals to transmit and receive data.
